(19) United States
(12) Patent Application Publication
(10) Pub. No.: US 2026/0228857 A1
(43) Pub. Date: Aug. 6, 2026

(54) Systems and Methods for Preserving Creative Intent at Different Levels-of-Detail

(71) Applicant: Illuscio, Inc., Culver City, CA (US)

(72) Inventors: Joseph Nordling, Roeland Park, KS (US); Joseph Bogacz, Perth (CA)

(73) Assignee: Illuscio, Inc., Culver City, CA (US)

(21) Appl. No.: 19/045,922

(22) Filed: Feb. 5, 2025

(51) Int. Cl. G06T 3/4092; G06T 9/00; G06T 15/20; G06V 10/764; G06V 20/40

(52) U.S. Cl. CPC G06T 3/4092; G06T 9/001; G06T 15/20; G06V 10/764; G06V 20/41; G06T 2210/32; G06T 2210/36

(57) ABSTRACT

A streaming system and associated methods are provided to preserve creative intent for three-dimensional (3D) content that is streamed at different levels-of-detail (LoDs). The streaming system receives original content and encodes the original content at the different LoDs. The streaming system presents the same sample moment from the original content and modified content that is generated at a first LoD. The streaming system receives feedback regarding a presentation of the creative intent at the first LoD in the sample moment from the modified content, and trains a classification model based on the feedback. The streaming system classifies the presentation of the creative intent at the first LoD in other frames, visualizations, or parts of the modified content, and streams the modified content at the first LoD to a client device in response to classifying the presentation of the creative intent at the first LoD as acceptable.

### BACKGROUND

Content is generated at different levels-of-detail (LoDs) to accommodate streaming or distribution over different network links to different user devices with different rendering and/or streaming capabilities. The content at each LoD is associated with a different amount of loss and is encoded with a different amount of data. The loss and/or data total may be the result of using fewer pixels or primitives to represent the content, reducing positional and/or color accuracy (e.g., 16-bit data types to 8-bit data types), reducing lighting accuracy, and/or otherwise degrading detail or quality in order to reduce the amount of data that represents the content at lower LoDs.

The increased loss associated with the lower LoDs results in the content deviating more and more from the original creative intent. The creative intent may be represented directly through any combination of visual elements or attributes or indirectly through a feeling, tone, mood, or other emotion that is established through the artistic expression in a frame or visualization of the content or at a specific part of the frame or visualization. For instance, the mood or impact of a scene or a visualization may be lost if certain detail is removed (e.g., the expressions on an actor's face, the lighting variation in a dark scene, etc.) to accommodate streaming over a restricted network.

If the creative intent is lost in one or more of the generated LoDs, the content creator may remove the content entirely or the affected LoDs to prevent different experiences when viewing the content at the different LoDs. The content creator may also remove the content or the affected LoDs to preserve the original artistic expression or the original creative intent rather than present the modified content with the lost creative intent.

### BRIEF DESCRIPTION OF THE DRAWINGS

FIG. 1 illustrates an example of preserving creative intent in three-dimensional (3D) content that is generated at different levels-of-detail (LoDs) in accordance with some embodiments presented herein.

FIG. 2 presents a process for preserving the creative intent in 3D content that is generated at different LoDs in accordance with some embodiments.

FIG. 3 illustrates an example of training a classification model that is used to detect and classify the creative intent in 3D content at different LoDs in accordance with some embodiments presented herein.

FIG. 4 illustrates an example of automated creative intent detection assistance in accordance with some embodiments presented herein.

FIG. 5 illustrates an example toolset for identifying creative intent changes in the presented sample moments in accordance with some embodiments presented herein.

FIG. 6 presents a process for regenerating 3D content at different LoDs based provided feedback in accordance with some embodiments presented herein.

FIG. 7 presents a process for classifying and adapting to changing creative intent in 3D content that is generated at different LoDs in accordance with some embodiments.

FIG. 8 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and associated methods for preserving creative intent for three-dimensional (3D) content that is streamed at different levels-of-detail (LoDs). The systems and methods may use machine learning techniques to analyze the creative intent as presented in the content's original form and to detect changes to the creative intent in different LoD representations of that content.

The content may include static 3D environments as well as changing 3D environments such as 3D animations, 3D movies, 3D games, and/or 3D interactive environments. The creative intent may be isolated to different parts of different scenes, may be embodied through the presentation of specific objects from specific angles or viewpoints, and/or varying combinations of visual elements or attributes in the different parts of the different scenes. For instance, the creative intent may be defined based on one or more of the positioning, scale, color, lighting, opacity, and/or other attributes of the primitives in the different parts of the different scenes. The creative intent may also be indirectly defined as a feeling, tone, mood, or other emotion that is established through the artistic expression in a frame or visualization of the content or at a specific part of the frame or visualization. In any case, the machine learning techniques may define the creative intent from user comments regarding the acceptability of the creative intent as presented in the same samples or snippets of the content at different LoDs.

The systems and methods may include automatically evaluating the acceptability of the creative intent in all frames, visualizations, and/or parts of the 3D content at the different LoDs based on the creative intent feedback obtained for the same samples or snippets, thereby freeing the users from having to observe and comment on the presentation of the creative intent in every frame, visualization, and/or part of the 3D content at each LoD. The systems and methods may include regenerating the content at specific LoDs to restore or preserve the creative intent that is lost or significantly affected in a prior encoding of those specific LoDs. Regenerating the content may include generating a specific LoD with a disproportionate reduction of the content attributes or parts of a scene that do not affect the creative intent and a minimal reduction of the content attributes or other parts of the scene that affect the creative intent. In other words, the content may be generated at the different LoDs to maintain the size reduction necessary for each LoD while prioritizing the size reduction to certain attributes or parts that do not affect the creative intent of the original content.

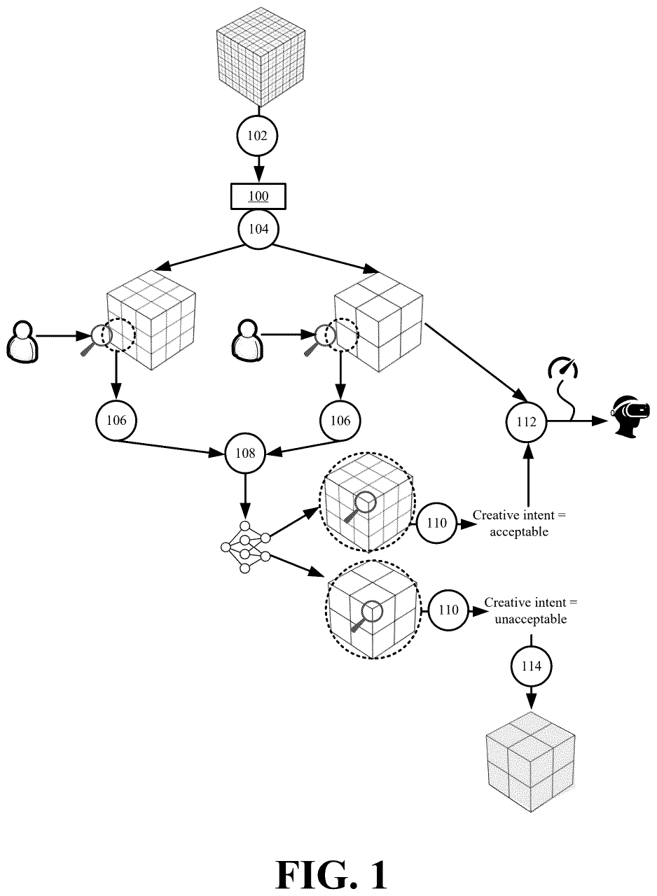

FIG. 1 illustrates an example of preserving creative intent in 3D content that is generated at different LoDs in accordance with some embodiments presented herein. Streaming system 100 receives (at 102) original content for distribution to different client devices across different network links. The different client devices and the different network links have different rendering and/or streaming performance and support viewing of the original content at different LoDs. The original content may include two-dimensional (2D) or 3D content such as images, videos, movies, games, and/or interactive or spatial computing experiences.

Streaming system 100 converts the original content to a 3D format and/or encodes (at 104) the converted 3D content at the different LoDs. For instance, streaming system 100 may encode a 2D video as different Gaussian splat representations with each Gaussian splat representation being defined with a different number of splats that recreate the 2D video in three dimensions at different LoDs. More specifically, a first Gaussian splat representation may be defined with 5 million splats for each video frame in order to present each frame in three dimensions at a first LoD, and a second Gaussian splat representation may be defined with 3 million splats for each video frame in order to present each frame in three dimensions at a reduced second LoD. In this example, the second Gaussian splat representation has a smaller file size and/or is encoded with less data than the first Gaussian splat representation. Moreover, the second Gaussian splat representation presents each frame with less detail and lower visual accuracy relative to the original content than the first Gaussian splat representation. In some embodiments, the original content may be converted and/or encoded (at 104) as different point clouds or mesh representations. In some such embodiments, a first point cloud representation at a first LoD may generate a 3D representation of the original content with a first number of points and a second point cloud representation at a second LoD may generate a 3D representation of the original content with a different second number of points. In some other embodiments, streaming system 100 encodes (at 104) the original content from a first 3D format to a compressed or reduced second 3D format. For instance, the original content may be 3D content that is encoded as a point cloud. Streaming system 100 may convert the point cloud to different Gaussian splat representations that are each smaller in size than the point cloud and that present the 3D content of the point cloud with differing amounts of loss.

Streaming system 100 generates the 3D content at the different LoDs to support or accommodate different streaming thresholds. For instance, the 3D content at a first LoD may be encoded with a first amount of data that may be streamed without buffering or interruption over a data network link with a first amount of bandwidth, and the 3D content at a second LoD may be encoded with a different second amount of data that may be streamed without buffering or interruption over a data network link with a second amount of bandwidth. In other words, streaming system 100 encodes (at 104) the original content at the different LoDs to provide a consistent 3D streaming experience for client devices with different 3D rendering performance and/or different network/streaming performance.

Streaming system 100 obtains (at 106) user feedback about the presentation of the creative intent at specific parts in the different LoD encodings of the 3D content. For instance, the user feedback may indicate that the detail of an actor's face is adequality preserved in a particular scene from a particular viewpoint in the encodings at the first and second LoDs, but that the detail is lost in the encodings at the third and fourth LoDs. The creative intent may vary from content to content and/or from scene to scene in the same 3D content.

Streaming system 100 trains (at 108) a machine learning model based on the user feedback. Training (at 108) the machine learning model may include determining the visual elements that are associated with the creative intent, and determining the changes in the visual representation of those visual elements that result in the creative intent being lost. In some embodiments, training (at 108) the machine learning model includes training a global model to recognize different creative intent in similar 3D content based on feedback obtained for the creative intent of the similar 3D content, and biasing the global model according to the user feedback obtained for the creative intent of the current 3D content at the different LoDs.

Streaming system 100 classifies (at 110) the 3D content at each LoD based on the trained (at 108) machine learning model. The classification (at 110) includes analyzing each frame, visualization, or part (e.g., different perspective or angle) of the 3D content at each LoD, and determining whether the creative intent, when detected in the frame or visualization, is presented and/or rendered with an amount of fidelity or quality that is acceptable relative to the obtained (at 106) user feedback and/or the modeling of acceptable creative intent in the machine learning model.

Streaming system 100 determines whether to stream the 3D content based on the classifications (at 110) for each LoD. For instance, streaming system 100 may stream (at 112) the 3D content when a sufficient number of LoDs are classified (at 110) to preserve the creative intent or when a particular low LoD encoding that is sufficient for most client devices is classified (at 110) to preserve the creative intent. In response to determining that a majority of client devices will be unable to view the 3D content with the creative intent preserved, streaming system 100 may remove the 3D content from streaming or may reencode (at 114) the 3D content at the different LoDs to reduce attributes that are unrelated to or do not affect the creative intent and to retain attributes that are related to or do affect the creative intent.

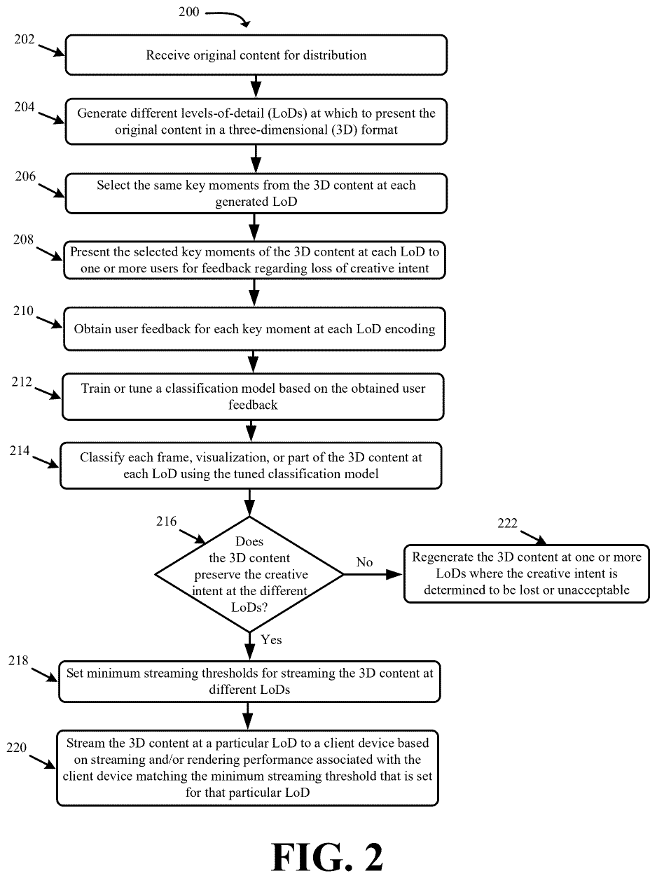

FIG. 2 presents a process 200 for preserving the creative intent in 3D content that is generated at different LoDs in accordance with some embodiments. Process 200 is implemented with streaming system 100. Streaming system 100 may be a streaming service provider or platform of 3D content from which different client devices may request and receive the 3D content. The 3D content may include 3D videos, animations, movies, games, and/or interactive or spatial computing experiences. Streaming system 100 may include one or more devices or machines with processor, memory, storage, network, and/or other hardware resources that are remotely accessible over a data network by the client devices and that generate and distribute the 3D content at different LoDs with the creative intent of the original 3D content preserved at each LoD.

Process 200 includes receiving (at 202) original content for distribution to different client devices at different LoDs based on streaming and/or rendering performance associated with the different client devices. The original content may be uploaded or otherwise provided to streaming system 100. The original content may include static or dynamic content. The static content may include a fixed image or a static 3D environment. The dynamic content may include videos, movies, games, interactive experiences, spatial computing experiences, and/or other content that changes programmatically, as created, or in response to user input. The original content may be in a 2D format or a 3D format. Streaming system 100 distributes the original content in a 3D format for viewing on spatial computing devices, 3D headsets, holographic projectors, and/or other 3D viewing devices.

Process 200 includes generating (at 204) different LoDs at which to present the original content in a 3D format. In some embodiments, generating (at 204) the different LoDs may include converting the original content from a 2D format to a 3D format. In some such embodiments, streaming system 100 may use artificial intelligence and/or neural networks to add volume to 2D shapes and objects. For instance, streaming system 100 may classify the objects appearing in the 2D content, retrieve 3D models of the classified objects, and generate the 3D content with the 3D models in place of the classified objects. Similarly, streaming system 100 may approximate the shape and curvature of the objects appearing in the 2D content and create 3D models of the objects based on the approximated shape and curvature. In some embodiments, generating (at 204) the different LoDs may include converting the original content from a first 3D format to a second 3D format that is better suited for streaming than the first 3D format. For instance, the original content may be represented in a point cloud format, and streaming system 100 may replace two or more points of the point cloud format with a mesh or splat in order to generate (at 204) the different LoDs and encode the original content with less data using the mesh or splat primitives of the second 3D format.

In any case, generating (at 204) the different LoDs includes generating 3D representations of the original content with each lower LoD is encoded with less data and more loss than a next higher LoD. The lower LoDs result in lower quality or less accurate visualizations of the original content. For instance, a first encoding at a first LoD may use 8-bit data types to define the positions and color values for 3D primitives that recreate the original content, and a second encoding at a second LoD may use 4-bit data types to define the positions and color values for the 3D primitives. The second LoD may be half the size of the first LoD but may recreate the original content less accurately and/or with greater loss than the first LoD. In some other embodiments, each lower LoD is generated with fewer 3D primitives of a larger size than a higher LoD. For instance, a first encoding at a first LoD may be defined with 5 million points, meshes, or splats of a small first size to recreate the original content with a first amount of loss, and a second encoding at a second LoD may be defined with 1 million points, meshes, or splats of a large second size to recreate the original content with a second amount of loss that is greater than the first amount of loss.

Process 200 includes selecting (at 206) the same key moments from the 3D content at each generated (at 204) LoD. For static 3D content, selecting (at 206) the same key moments may include selecting one or more of the same fields-of-view at which the static 3D content is first presented and/or is viewed by a majority of users. For changing or dynamic 3D content, selecting (at 206) the same key moments may include selecting a sampling of frames or 3D visualizations for high complexity, medium complexity, and low complexity scenes. Since the generated content is 3D, the sampling of frames or 3D visualizations may be from a default or primary field-of-view or viewing angle. In some other embodiments, selecting (at 206) the same key moments includes snippets or segments from different scenes in the 3D content. For instance, the 3D content may be a 3D video or movie and the key moments may include 3-second snippets or segments from every five minutes of the 3D video or movie. In some embodiments, streaming system 100 selects (at 206) the same key moments by analyzing the 3D content for visual differentiation (e.g., changing scenes, different events, new objects, etc.) and determining the primary angle or viewing perspective at which the scenes with the visual differentiation are likely to be viewed. The 3D content allows a user to freely change the camera position and to view the 3D environment from any position. However, the 3D content may include a default camera path at which the 3D content is presented to viewers and the default camera path may be used to select the primary field-of-view, angle, or viewing perspective at which to present each key moment. Additionally, streaming system 100 may track the camera position to determine the primary field-of-view, angle, or viewing perspective at which a majority of users view each key moment, and may set the primary field-of-view, angle, or viewing perspective for each key moment based on the tracked camera path.

Process 200 includes presenting (at 208) the selected (at 206) key moments of the 3D content at each LoD to one or more users for feedback regarding loss of creative intent. The one or more users may include persons that are familiar with the creative intent of the original content, and may include directors, artists, editors, content creators, colorists, and/or other individuals that assisted in generating or creating the original content. Presenting (at 208) the selected (at 206) key moments may include displaying a key moment from the original content next to the same key moment from each LoD encoding so that the one or more users may compare how the creative intent has changed in each LoD encoding.

In some embodiments, presenting (at 208) the selected (at 206) key moments may include displaying the same part of the 3D content from the same angle at each LoD and from the same part of the original content. In some embodiments, presenting (at 208) the selected (at 206) key moments may include synchronizing the playback of the same frames or changing visualization of the 3D content at the different LoDs so that the same segments or snippets at the different LoDs may be compared against one another or against the same segments or snippets of the original content.

Process 200 includes obtaining (at 210) user feedback for each key moment at each LoD encoding. In some embodiments, the user feedback may include a classification for the creative intent in the presented (at 208) key moments. The classification may include a binary label such as “acceptable” or “unacceptable”. The acceptable label is provided when a user providing the user feedback determines that the creative intent is presented with sufficient detail in the key moment of a particular LoD encoding to preserve or retain the original creative intent from that key moment in the original content. The unacceptable label is provided when the user determines that the creative intent is lost in the key moment of the particular LoD encoding due to lossy encoding techniques, compression, change in primitives or formats, and/or other changes resulting generating the particular LoD encoding. In some embodiments, the user feedback includes more detailed identification for the changes to the creative intent. For instance, the user feedback may include marking the regions where the creative intent is lost and/or using a toolset to specify adjustments to restore the creative intent. For instance, when presenting (at 208) the selected (at 206) key moments, streaming system 100 may provide a toolset with which the users may adjust color values, opacity, reflectivity, and/or specify other edits to the presented (at 208) key moments. The edits may include circling or highlight a region where the loss of creative intent is detected and/or specifying what the loss entails (e.g., lost detail, color inaccuracy, lighting inaccuracy, distorted scale, etc.).

Process 200 includes training or tuning (at 212) a classification model based on the obtained (at 210) user feedback. The classification model may be trained based on user feedback that is obtained for classifying the creative intent in other content at various LoDs. In some embodiments, the classification model is trained on the user feedback provided by the same one or more users for other content. For instance, the user feedback from the same creative team or the same production studio may be used to train the classification model on the creative intent that the creative team or production studio values or prioritizes in the content they create or submit for streaming. Tuning (at 212) the classification model includes weighting the classification model towards the creative intent identified in the current content and/or how the creative intent is evaluated in the current content based on the obtained (at 210) user feedback. For instance, if the user feedback classifies the creative intent in key moments as acceptable or unacceptable based on the presences or absence of an actor's face and/or the sharpness of the actor's face in the presented (at 208(+) key moments, then streaming system 100 tunes (at 212) the classification model to prioritize detail in a human face over other attributes (e.g., color, lighting, detail in other objects, etc.). Similarly, if the user feedback classifies the creative intent in the presented (at 208) key moments as acceptable or unacceptable based on color accuracy in scenes with lots of color variations, then streaming system 100 tunes (at 212) the classification model to prioritize color accuracy over positional accuracy, lighting accuracy, opacity, and/or other attributes.

Process 200 includes classifying (at 214) each frame, visualization, or part of the 3D content at each LoD using the tuned (at 212) classification model. The classification (at 214) involves analyzing each frame, visualization, or part of the 3D content at each LoD for the creative intent, and determining whether the creative intent from the original content is preserved or lost in the analyzed frames, visualizations, or parts where the creative intent is detected. Some frames, visualizations, or parts may not include the creative intent that is identified from the user feedback. For instance, the creative intent may be defined in terms of accuracy of a particular color, details of a particular actor or object, and/or lighting in specific dark scenes. Accordingly, frames, visualizations, or parts of the 3D content at each LoD that do not include the particular color, particular actor or object, or are not part of the dark scenes may be classified as “acceptable” (e.g., preserving the creative intent) or may not be classified. The classification (at 214) involves automatically applying the classification criteria provided in the user feedback across all frames or moments of the 3D content.

Process 200 includes determining (at 216) whether the generated (at 204) 3D content provides a common experience that preserves the creative intent at the different LoDs based on the classification (at 214). The determination (at 216) may be based on the number or percentage of frames, visualizations, or parts of the 3D content at each LoD where the creative intent is preserved versus where the creative intent is lost.

Process 200 includes setting (at 218) minimum streaming thresholds for streaming the 3D content at different LoDs in response to determining (at 216—Yes) that the 3D content provides a common experience and/or preserves the original creative intent at the different LoDs. Setting (at 218) the minimum streaming thresholds includes determining the minimum streaming and/or rendering performance required for streaming each LoD encoding that is determined to preserve the creative intent. More specifically, the minimum streaming threshold set (at 218) for the 3D content at a particular LoD is the minimum amount of streaming (e.g., bandwidth) and/or rendering resources required to receive and render the 3D content at the particular LoD without delay or interruption.

Process 200 includes streaming (at 220) the 3D content at a particular LoD to a client device based on streaming and/or rendering performance associated with the client device matching the minimum streaming threshold that is set for that particular LoD. Streaming system 100 streams (at 220) the primitives (e.g., splats, points, or meshes) that are defined for the 3D content at the particular LoD, wherein the collective amount of data associated with the streamed (at 220) primitives is within the amount of data that may be streamed to and rendered by the client device without buffering or delay that would otherwise create an interrupted user experience.

Process 200 includes regenerating (at 222) the 3D content at one or more LoDs in response to determining (at 216—No) that the 3D content at the one or more LoDs does not provide a common experience as a result of the creative intent being lost at the one or more LoD. Regenerating (at 222) the 3D content may include encoding the original content at the one or more LoDs with additional weight being assigned to preserve the visual elements and/or attributes that are determined to affect the creative intent. For instance, if the creative intent focuses on maintaining detail in an actor's face, regenerating (at 222) the 3D content may include using larger data types (e.g., 4-byte variables instead of 2-byte variables) to store the positional data and smaller data types (e.g., 2-byte variables) to store other data (e.g., color values, opacity, lighting, etc.).

In some embodiments, streaming system 100 may discard or remove the 3D content or the one or more LoDs that lose the creative intent from streaming rather than regenerate (at 222) the 3D content. In some embodiments, streaming system 100 may discard or remove the 3D content at specific LoDs from streaming when those specific LoDs cannot be regenerated (at 222) to preserve the creative intent while also satisfying minimum streaming thresholds that are set (at 218) for those specific LoDs.

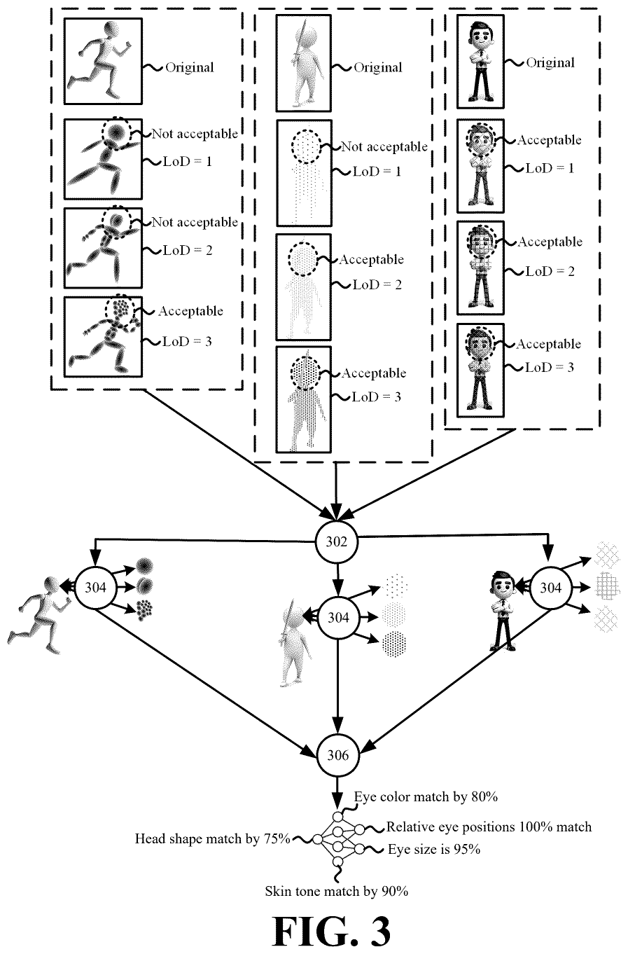

FIG. 3 illustrates an example of training the classification model that is used to detect and classify the creative intent in 3D content at different LoDs in accordance with some embodiments presented herein. Training the classification model includes providing (at 302) different original content, different LoD encodings of the original content, and labels for different parts of the LoD encodings as training data.

The original content contains and presents an unmodified representation of the creative intent. The creative intent may be tied to specific attributes (e.g., positional detail, color, lighting, etc.), tied to specific parts of the original content, and/or may be generally defined as a mood, expression, or other representation that is a combination of different visual elements in a frame or scene.

The different LoD encodings may distort or lose some of the creative intent. The distortion or loss may be the result of converting the content format, using less data to represent the original content, compression, and/or other lossy effects of reencoding the original content to generate each of different LoD encodings.

The labels may include binary values for specifying whether the creative intent is sufficiently preserved or is lost in specific parts of the different LoD encodings. For instance, a particular part of a first LoD encoding of specific original content may reproduce the creative intent in that particular part of the specific original content with minimal or unnoticeable loss and may be assigned a first acceptable label. The particular part of a second LoD encoding may reproduce the creative intent in that particular part of the specific original content with significant loss and may be assigned a second unacceptable label.

In some embodiments, the labels may be more descriptive. In some such embodiments, the labels may specifically identify one or more visual elements or attributes that make up part or all of the creative intent and/or may include values that specify how far the visual elements or attributes deviate from the original creative intent. For instance, the label may specify that the shadows are overly dark by 10% or that the blue color of the sky needs to be reduced by 20%.

The classification model receives the training data and compares (at 304) the original content and/or LoD encodings that are labeled as preserving the creative intent against the LoD encodings that are labeled as not preserving the creative intent in order to determine the visual elements and attributes that define or affect the creative intent. The comparison may include performing pattern detection in order to detect what has changed between the same parts of the 3D content at the different LoD encodings and/or for quantifying the changes in terms of visual elements or attributes for the 3D primitives that create the visualization for the compared parts. In other words, the classification model analyzes the changes for the same part of the 3D content across the different LoD encodings in order to define the focus of the creative intent for that 3D content.

The classification model may also detect patterns or trends in the visual elements or attributes that affect the creative intent in the different original content at their respective LoD encodings. For instance, the classification model may detect that positional accuracy affecting facial detail is a focus of creative intent in a threshold percentage of the original content. In some such embodiments, the classification model may classify the subject of the original content in order to detect common creative intent across original content pertaining to the same subject or classification (e.g., action movies, animated videos, racing games, etc.).

The classification model defines (at 306) sets of vectors based on the patterns, commonality, and/or visual elements or attributes that are determined to affect the creative intent in the training data. Defining (at 306) the sets of vectors may include creating different sets of connected nodes or neurons with each node or neuron representing a different visual element or attribute that is associated with the definition of the creative intent in specific original content or content of a specific classification. Each node or neuron may be weighted to signify the amount with which the visual element or attribute represented by that node or neuron affects the creative intent and/or to specify the amount of loss or change that the visual element or attribute may receive before the creative intent is lost. For example, the classification model of FIG. 3 may be detect and/or define creative intent based on patterns or commonality found about a character head or face. In this example, a first vector of the classification model may determine that the creative intent at a specific LoD is preserved if the head shape matches the head shape of the original content by 75%, the eye color matches the eye color of the original content by 80%, and the relative eye positions in the specific LoD match by 100% to the relative eye positions in the original content, and a second vector of the classification model may determine that the creative intent at the specific LoD is preserved if the head shape matches the head shape of the original content by 75%, the skin tone matches the skin tone of the original content by 90%, and the size of the eyes matches the size of the eyes in the original content by 95%.

The classification model may be refined or tuned based on specific feedback that is obtained for new content that is being analyzed for creative intent preservation. The specific feedback may be provided as additional training data that is weighted more heavily than the other training data in order to bias the classification model to the specific creative intent that users have identified or otherwise considered in providing the specific feedback. For instance, the specific feedback may add greater weight to matching the eye color of the character or may lessen the importance of the hair from an LoD encoding accurately matching the hair from the original content.

In some embodiments, streaming system 100 assists users in identifying the changes between the different LoD encodings and the original content. Streaming system 100 analyzes the original content against the 3D content at the different LoDs and provides metrics for the changes that are detected in the different LoD encodings.

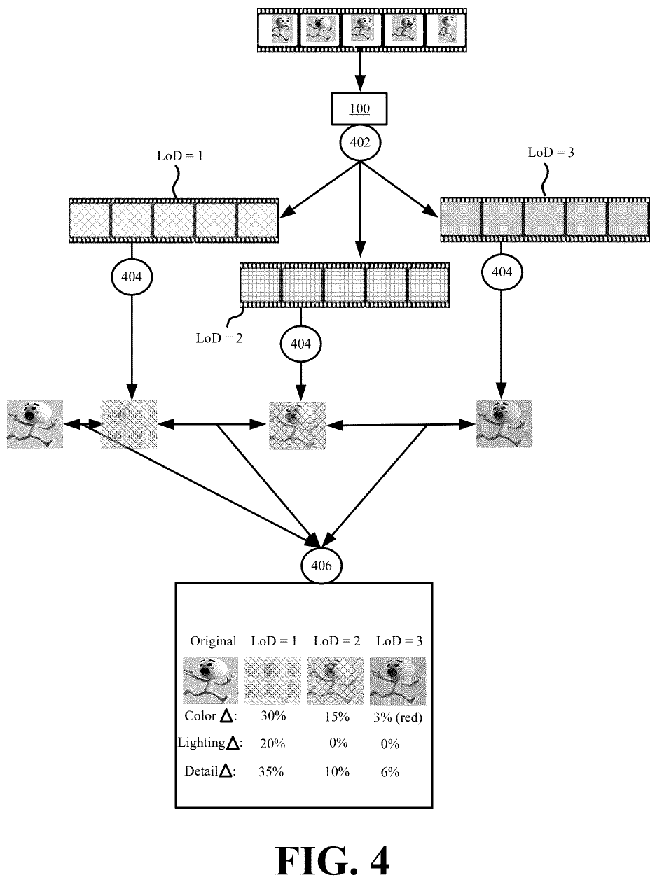

FIG. 4 illustrates an example of the automated creative intent detection assistance in accordance with some embodiments presented herein. Streaming system 100 encodes (at 402) original content at different LoDs, and selects (at 404) sample moments representing the same part of the content at the different LoDs to present to one or more users for feedback regarding changes to the creative intent.

Prior to presenting the sample moments, streaming system 100 compares the sample moment at each LoD against the same part from the original content. Streaming system 100 evaluates and quantifies the differences or changes detected at each LoD. For instance, streaming system 100 quantifies an amount by which the positions of features deviate between the original content and the compared LoD, an amount by which the colors and/or lighting deviate, an amount of distortion or loss detected between the original content and the compared LoD, and/or other calculable deviations between the compared parts.

Streaming system 100 presents (at 406) the sample moments with the results of the comparisons to highlight what has changed at each LoD for the users. The users may focus on the changes that affect the creative intent, and then perform a visual inspection to ascertain if the changes result in significant loss to the creative intent.

Streaming system 100 may also provide a toolset with which users identify the unacceptable changes to the creative intent. The user feedback obtained via the toolset may provide additional data from which the classification model is better able to detect the creative intent for each content and to regenerate the LoD encodings to better preserve that creative intent.

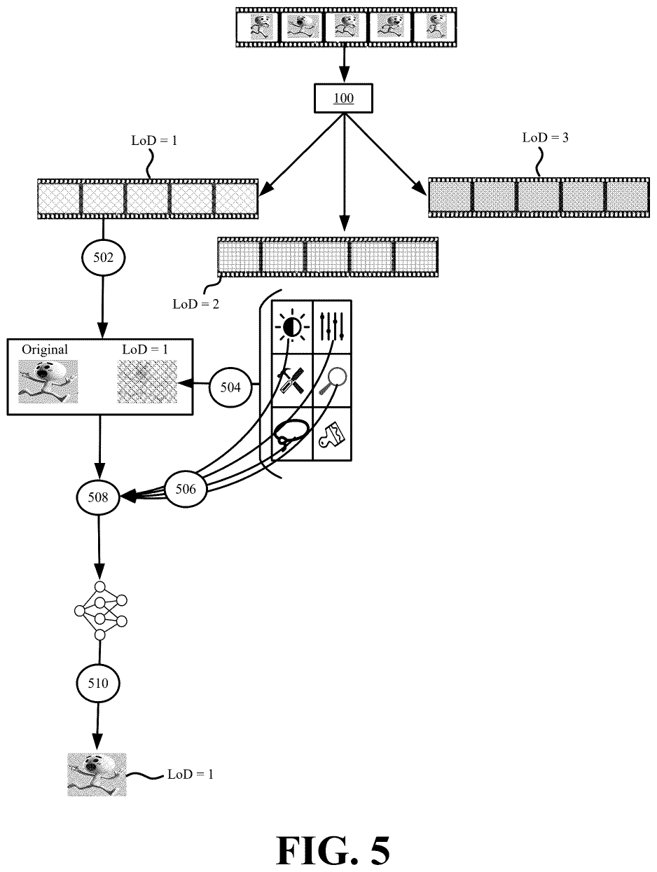

FIG. 5 illustrates an example toolset for identifying creative intent changes in the presented sample moments in accordance with some embodiments presented herein. Streaming system 100 presents (at 502) a sample moment from the original content and the same sample moment as represented in a lower LoD encoding of the original content. Streaming system 100 may also compare the sample moments and present quantifiable changes that are detected between the sample moments.

Streaming system 100 provides (at 504) a toolset for editing various visual elements and/or attributes of the lower LoD encoding. The toolset is provided in a graphical user interface and includes selectable user interface (UI) elements for independently adjusting the various visual elements and/or attributes and/or for selecting parts of the sample moment to adjust independent of other parts. For instance, the toolset may include a UI element for changing brightness, a UI element for adjusting colors (e.g., red, green, and blue), a UI element scaling or transforming the sample moment at the lower LoD, a UI element for selecting a part of the sample moment to adjust, and/or a UI element for changing the sharpness or detail.

Streaming system 100 receives (at 506) adjustments that the user makes to the sample moment of the lower LoD encoding using the toolset. The user makes adjustments that restore the creative intent or that adjust the lower LoD encoding to present the creative intent in an acceptable manner.

Streaming system 100 inputs (at 508) the adjustments as training data for the classification model. The classification model analyzes the adjustments to identify the focus of the creative intent in the sample moment and to identify the visual elements and attributes that affect the creative intent in the sample moment. In other words, the classification model defines vectors to identify the creative intent based on the adjustments.

Streaming system 100 may also use the adjustments obtained through the toolset to regenerate (at 510) the LoD encodings that fail to preserve the creative intent. In some embodiments, streaming system 100 adjusts loss functions associated with different visual elements and/or attributes in order to regenerate the 3D content at a specific LoD that preserves the visual elements and/or attributes associated with the creative intent while reducing the data associated with other visual elements and/or attributes that do not affect the creative intent.

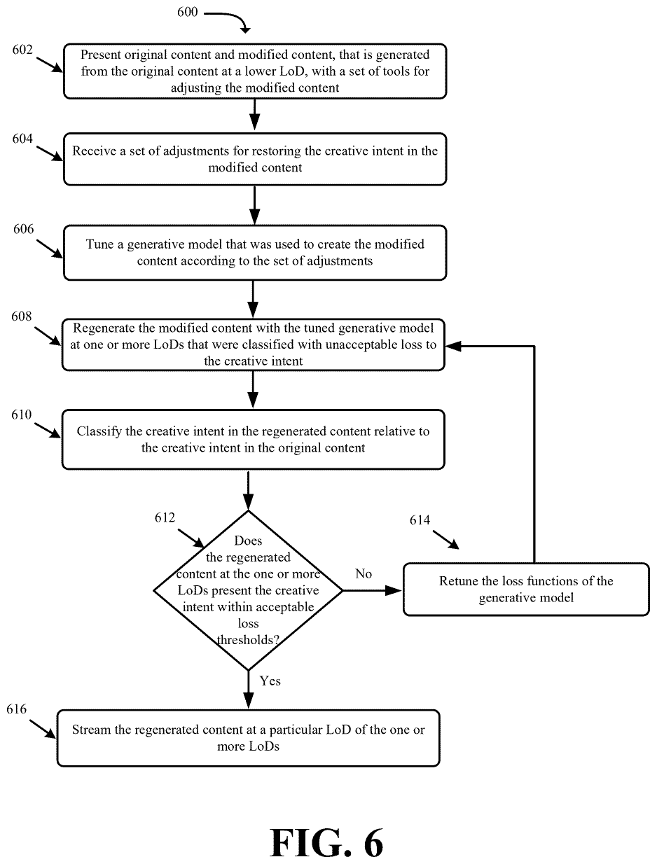

FIG. 6 presents a process 600 for regenerating 3D content at different LoDs based provided feedback in accordance with some embodiments presented herein. Process 600 is implemented by streaming system 100.

Process 600 includes presenting (at 602) original content and modified content, that is generated from the original content at a lower LoD, with a set of tools for adjusting the modified content. The content is presented to one or more users that may compare the original content to modified content in order to determine if the modified content preserves or loses the creative intent from the original content.

Process 600 includes receiving (at 604) a set of adjustments that the one or more users make to restore the creative intent in the modified content. Streaming system 100 provides the toolset by which the users may adjust different visual elements and/or attributes of the modified content or in selected parts of the modified content. The set of adjustments may include adjustments to specific color values (e.g., red, green, or blue color values), lighting, shadows, highlights, reflectivity, scale of the primitives used to form different parts of the 3D content, and/or other adjustments related to the detail or visualization of the content at the lower LoD. For instance, the user adjustments may specify increasing detail at a specific part of the modified content by selecting the specific part and by increasing the number of primitives that are used to represent that specific part by some amount or percentage.

Process 600 includes tuning (at 606) a generative model that was used to create the modified content according to the set of adjustments. Tuning (at 606) the generative model includes adjusting various loss functions by which the generative model verifies whether the modified content is produced within acceptable tolerances of the original content. For instance, the generative model may first generate the modified content at the different LoDs by varying the acceptable amount of loss associated with a single or all-encompassing loss function. Streaming system 100 may set the loss function to 95% in order to generate the content at a first LoD. The generative model may iteratively generate different sets of primitives (e.g., Gaussian splats) to represent the original content, may compare each generated set of primitives against the original content, and may select the set of primitives that produces a visualization that varies by less than 5% from the original content and that has the greatest data reduction relative to the original content. Streaming system 100 may then set the loss function to 80% in order to generate the modified content at a second LoD. The generative model may iteratively generate different set of primitives to represent the original content, may compare each generated set of primitives against the original content, and may select the set of primitives that produce a visualization that varies by less than 20% from the original content and that has the greatest data reduction relative to the original content. In tuning (at 606) the generative model, streaming system 100 configures different loss functions for different visual elements or attributes of the primitives created by the generative model based on the received (at 604) set of adjustments. For instance, streaming system 100 may configure a first loss function that controls positional accuracy, a second loss function that controls color accuracy, a third loss function that controls opacity accuracy, and/or other loss functions for other visual elements or attributes of the primitives. In response to the set of adjustments indicating that the creative intent was lost due to positional inaccuracy, streaming system 100 tunes (at 606) the first loss function that controls the positional accuracy to accept less loss than the other loss functions controlling other visual elements or attributes of the primitives being generated. Similarly, in response to the set of adjustments indicating that the creative intent was lost due to color inaccuracy, streaming system 100 tunes (at 606) the second loss function that controls the color accuracy to accept less loss than the other loss functions controlling other visual elements or attributes of the primitives.

Process 600 includes regenerating (at 608) the modified content with the tuned (at 606) generative model at one or more LoDs that were classified with unacceptable loss to the creative intent. Regenerating (at 608) the content includes using machine learning techniques or a neural network to define the positioning and visual characteristics of the primitives with different amounts of acceptable loss as specified in the tuned (at 606) generative model. As a result, the visual elements or attributes of the primitives that affect the creative intent are defined with more data, less loss, and/or more accurately than the visual elements or attributes that do not affect the creative intent.

Process 600 includes classifying (at 610) the creative intent in the regenerated (at 608) content relative to the creative intent in the original content, and determining (at 612) whether the regenerated (at 608) content at the one or more LoDs presents the creative intent within acceptable loss thresholds. Classifying (at 610) the creative intent may include presenting segments or samples of the regenerated (at 608) content at the one or more LoDs with the same segments or samples from the original content for comparison and receiving user feedback regarding the creative intent. Classifying (at 610) the creative intent may include automatically determining whether the creative intent in different frames, visualization, and/or parts of the regenerated (at 608) are acceptably represented.

Process 600 includes retuning (at 614) the different loss functions of the generative model in response to determining (at 612—No) that the creative intent presented in the regenerated (at 608) content at the one or more LoDs is not within the acceptable loss thresholds. The loss functions are adjusted based on visual elements and attributes that affect the creative intent and that still deviate by more than a threshold amount from the creative intent of the original content. Process 600 may then regenerate (at 608) the modified content based on the retuned (at 614) loss functions of the generative model.

Process 600 includes streaming (at 616) the regenerated (at 608) content at a particular LoD of the one or more LoDs in response to determining (at 612—Yes) that the creative intent in the regenerated (at 608) at the particular LoD is within the acceptable loss thresholds. Streaming system 100 streams (at 616) the regenerated (at 608) content at the particular LoD in response to a client device request for the content and the streaming and/or rendering performance associated with the client device supports the particular LoD encoding of the content.

The creative intent may change in the original content as scenes change, objects in a scene change, different environments are presented, and/or different parts of the same environment are presented. In other words, there may be more than one creative intent that appears at different times or places in the original content. Accordingly, the training of the classification model and the tuning of the generative model may be performed on a scene-by-scene basis rather than for the entirety of the content. For instance, the content director may want a dark and scary mood for a first scene and a bright and cheerful mood for a second scene of the same content. In this instance, the same classification model or same creative intent cannot be used to classify the different scenes. The training and/or tuning of the models allows for streaming system 100 to detect, classify, and/or correct for the different creative intent at the different scenes of the content.

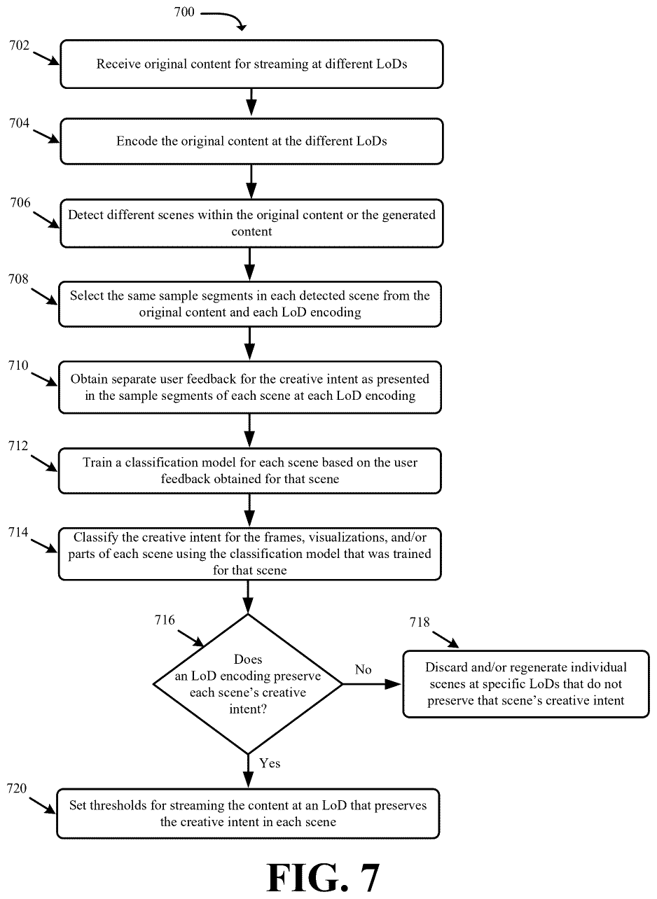

FIG. 7 presents a process 700 for classifying and adapting to changing creative intent in 3D content that is generated at different LoDs in accordance with some embodiments. Process 700 is implemented by streaming system 100.

Process 700 includes receiving (at 702) original content for streaming at different LoDs to client devices that support different streaming and/or rendering performance. Process 700 includes encoding (at 704) the original content at the different LoDs by increasing the amount of loss and decreasing the amount of data with which each LoD encoding represents the original content.

Process 700 includes detecting (at 706) different scenes within the original content or the generated content. The different scenes may be identified by abrupt changes from one frame or visualization of the content to a next, new objects come into the field-of-view, or when a configured amount or percentage of the visualization changes from one frame or visualization to the next.

Process 700 includes selecting (at 708) the same sample segments in each detected (at 706) scene from the original content and each LoD encoding. The sample segments include short excerpts, snippets, and/or parts from each scene. In other words, at least one sample moment or visualization is selected (at 708) for each scene to present the creative intent in that scene at the different LoDs.

Process 700 includes obtaining (at 710) separate user feedback for the creative intent as presented in the sample segments of each scene at each LoD encoding. In some embodiments, the user feedback is tagged with an identifier for the scene that the user feedback is associated with.

Process 700 includes training (at 712) a classification model for each scene based on the user feedback obtained (at 710) for that scene. In some embodiments, the training (at 712) involves adjusting the weighting of a global classification model trained on feedback from similar scenes of other content. In some such embodiments, the training (at 712) includes classifying or identifying the scene (e.g., action, bright, landscape, explosion, serene, dark, etc.), selecting a global classification model that was previously trained for the classified or identified scene, and adjusting the weights or vectors of the selected global classification model based on the user feedback obtained for the classified or identified scene of the current original content.

Process 700 includes classifying (at 714) the creative intent for the frames, visualizations, and/or parts of each scene using the classification model that was trained (at 712) for that scene. The classification models that are trained (at 712) for different scenes define and/or recognize the different creative intent that is pertinent or valued by the creative direction team for each scene, and may be used to determine if the different frames, visualizations, or parts of each scene at the different LoDs capture the creative intent for that scene within acceptable thresholds.

Process 700 includes determining (at 716) the LoD encodings that preserve each scene's creative intent as modeled from the per scene user feedback and based on the per scene classification (at 714). Process 700 includes discarding and/or regenerating (at 718) individual scenes at specific LoDs that do not preserve that scene's creative intent. Process 700 includes setting (at 720) thresholds for streaming the content at an LoD that preserves the creative intent in each scene. The thresholds are set (at 720) based on the amount of data that is associated with that LoD encoding and the minimum streaming and/or rendering performance that is needed for a seamless content experience at that LoD. The content may then be streamed to requesting client devices at the LoD that provides a seamless and/or uninterrupted experience based on each client device's streaming and/or rendering performance.

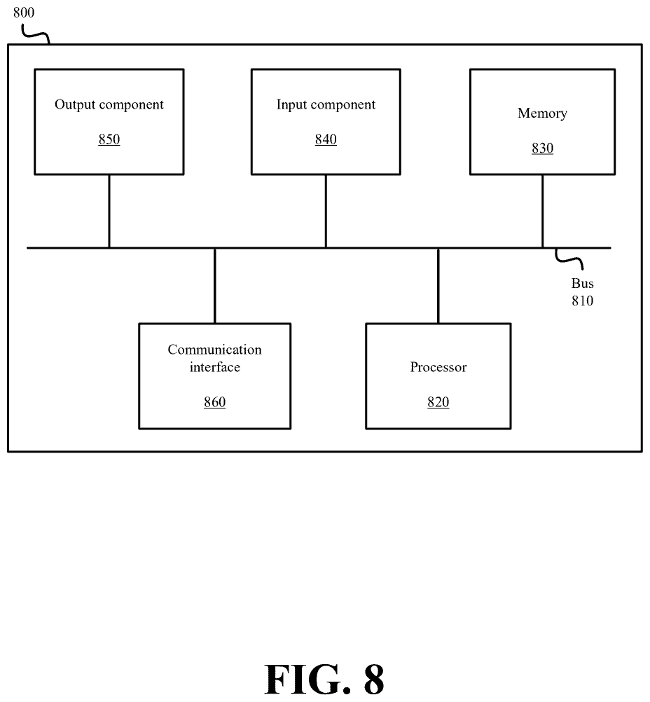

FIG. 8 is a diagram of example components of device 800. Device 800 may be used to implement one or more of the tools, devices, or systems described above (e.g., streaming system 100, client devices, etc.). Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more LEDs, etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving an original content for distribution to different client devices;
encoding the original content at different levels-of-detail (LoDs), wherein said encoding comprises generating a modified content at a first LoD that presents a creative intent from the original content with a first amount of loss;
presenting a sample moment that corresponds to a same frame, visualization, or part of the original content and the modified content;
receiving feedback regarding a presentation of the creative intent at the first LoD in the sample moment from the modified content;
training a classification model based on the feedback, wherein training the classification model comprises determining one or more visual elements and attributes that affect the creative intent based on the feedback;
classifying the presentation of the creative intent at the first LoD in other frames, visualizations, or parts of the modified content that are not within the sample moment using the classification model; and
streaming the modified content at the first LoD to a client device in response to classifying the presentation of the creative intent at the first LoD as acceptable.

2. The method of claim 1 further comprising:
setting a threshold at which to stream the modified content at the first LoD rather than the modified content at a second LoD; and
determining that one or more of a streaming performance or rendering performance associated with the client device satisfies the threshold.

3. The method of claim 1, wherein generating the modified content comprises:
converting the original content from a first three-dimensional (3D) format to a different second 3D format.

4. The method of claim 1, wherein generating the modified content comprises:
converting the original content from one of a point, mesh, or splat 3D format to another one of the point, mesh, or splat 3D format.

5. The method of claim 1, wherein said encoding further comprises:
generating the modified content at a second LoD that presents the creative intent from the original content with a second amount of loss that is greater than the first amount of loss, wherein the modified content at the second LoD is encoded with less data than the modified content at the first LoD.

6. The method of claim 1 further comprising:
measuring differences between the same frame, visualization, or part of the original content and the modified content; and
wherein presenting the sample moment comprises presenting said differences in a graphical user interface with the sample moment of the original content displayed adjacent to the sample moment of the modified content.

7. The method of claim 1 further comprising:
detecting a first scene and a different second scene in the original content; and
wherein selecting the sample moment comprises:
extracting a first frame, visualization, or part representing the creative intent in the first scene and a second frame, visualization, or part representing the creative intent in the different second scene from the original content and the modified content.

8. The method of claim 7, wherein training the classification model comprises:
training a first classification model for detecting and classifying the creative intent in the first scene based on feedback received for the first frame, visualization, or part; and
training a second classification model for detecting and classifying the creative intent in the different second scene based on feedback received for the second frame, visualization, or part.

9. The method of claim 1 further comprising:
regenerating the modified content at the first LoD in response to classifying the presentation of the creative intent at the first LoD as unacceptable.

10. The method of claim 1 further comprising:
determining that the creative intent as presented in modified content at the first LoD is lost based on said classifying; and
adjusting a plurality of loss functions of a generative model in response to determining that the creative intent is lost, wherein adjusting the plurality of loss functions comprises:
configuring a first loss function of the plurality of loss functions that controls a first visual element or attribute that affects the creative intent with a first amount of loss; and
configuring a second loss function of the plurality of loss functions that controls a second visual element or attribute that does not affect the creative intent with a second amount of loss, wherein the second amount of loss is greater than the first amount of loss.

11. The method of claim 10 further comprising:
regenerating the modified content at the first LoD with a new set of primitives that are defined with visual elements and attributes that match the first amount of loss of the configured first loss function and the second amount of loss of the configured second loss function.

12. The method of claim 1, wherein classifying the presentation of the creative intent comprises:
analyzing a presentation of the creative intent in each frame, visualization, or part of the other frames, visualizations, or parts against a derived model of the creative intent in the classification model; and
labeling each frame, visualization, or part with a creative intent classification based on said analyzing.

13. The method of claim 1,
wherein training the classification model further comprises:
isolating the creative intent to a particular part of the sample moment; and
wherein classifying the presentation of the creative intent comprises:
determining when the particular part representing the creative intent changes by more than a threshold amount in the other frames, visualizations, or parts of the modified content.

14. The method of claim 13, wherein classifying the presentation of the creative intent further comprises:
labeling a frame, visualization, or part of the other frames, visualizations, or parts of the modified content as losing the creative intent in response to determining that the particular part in that frame, visualization, or part changes by more than the threshold amount.

15. A streaming system comprising:
one or more hardware processors configured to:
receive an original content for distribution to different client devices;
encode the original content at different levels-of-detail (LoDs), wherein said encoding comprises generating a modified content at a first LoD that presents a creative intent from the original content with a first amount of loss;
present a sample moment that corresponds to a same frame, visualization, or part of the original content and the modified content;
receive feedback regarding a presentation of the creative intent at the first LoD in the sample moment from the modified content;
train a classification model based on the feedback, wherein training the classification model comprises determining one or more visual elements and attributes that affect the creative intent based on the feedback;
classify the presentation of the creative intent at the first LoD in other frames, visualizations, or parts of the modified content that are not within the sample moment using the classification model; and
stream the modified content at the first LoD to a client device in response to classifying the presentation of the creative intent at the first LoD as acceptable.

16. The streaming system of claim 15, wherein the one or more hardware processors are further configured to:
set a threshold at which to stream the modified content at the first LoD rather than the modified content at a second LoD; and
determine that one or more of a streaming performance or rendering performance associated with the client device satisfies the threshold.

17. The streaming system of claim 15, wherein said encoding further comprises:
generating the modified content at a second LoD that presents the creative intent from the original content with a second amount of loss that is greater than the first amount of loss, wherein the modified content at the second LoD is encoded with less data than the modified content at the first LoD.

18. The streaming system of claim 15, wherein the one or more hardware processors are further configured to:
measure differences between the same frame, visualization, or part of the original content and the modified content; and
wherein presenting the sample moment comprises presenting said differences in a graphical user interface with the sample moment of the original content displayed adjacent to the sample moment of the modified content.

19. The streaming system of claim 15, wherein the one or more hardware processors are further configured to:
determine that the creative intent as presented in modified content at the first LoD is lost based on said classifying; and
adjust a plurality of loss functions of a generative model in response to determining that the creative intent is lost, wherein adjusting the plurality of loss functions comprises:
configuring a first loss function of the plurality of loss functions that controls a first visual element or attribute that affects the creative intent with a first amount of loss; and
configuring a second loss function of the plurality of loss functions that controls a second visual element or attribute that does not affect the creative intent with a second amount of loss, wherein the second amount of loss is greater than the first amount of loss.

20. A non-transitory computer-readable medium storing instructions that, when executed by one or more processors of a streaming system, cause the streaming system to perform operations comprising:
receiving an original content for distribution to different client devices;
encoding the original content at different levels-of-detail (LoDs), wherein said encoding comprises generating a modified content at a first LoD that presents a creative intent from the original content with a first amount of loss;
presenting a sample moment that corresponds to a same frame, visualization, or part of the original content and the modified content;
receiving feedback regarding a presentation of the creative intent at the first LoD in the sample moment from the modified content;
training a classification model based on the feedback, wherein training the classification model comprises determining one or more visual elements and attributes that affect the creative intent based on the feedback;
classifying the presentation of the creative intent at the first LoD in other frames, visualizations, or parts of the modified content that are not within the sample moment using the classification model; and
streaming the modified content at the first LoD to a client device in response to classifying the presentation of the creative intent at the first LoD as acceptable.
